(19) United States
(12) Patent Application Publication
(10) Pub. No.: US 2004/0185174 A1
(43) Pub. Date: Sep. 23, 2004

(54) Color filter fabrication method

(75) Inventors: Sean Chang, Taoyuan City (TW); Chung-Ling Lu, Taipei (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: DELTA ELECTRONICS, INC.

(21) Appl. No.: 10/441,190

(22) Filed: May 20, 2003

(30) Foreign Application Priority Data
Mar. 21, 2003 (TW) 92106393

(51) Int. Cl. G02B 5/20

(52) U.S. Cl. 427/162; 204/192.26; 427/282; 427/164; 427/166

(57) ABSTRACT

The present invention describes a color filter fabrication method. According to the present invention, a removable mask and a substrate are placed in a vacuum evaporator. The removable mask is used to cover partially the substrate and expose the region where the first color dielectric layer forms. When finishing this evaporating process, the removable mask is rotated and moved to the next position, exposing another region where the second color dielectric layer is to be formed by the next evaporating process.

### FIELD OF THE INVENTION

The present invention relates to a filter fabrication method, and more particularly, to a color filter fabrication method.

### BACKGROUND OF THE INVENTION

A color filter is formed either by an adhesion method or by a photolithography method at present.

The photolithography method for forming a color filter with a blue color, a red color and a green color as shown in FIG. 1 is described in the following paragraphs. First, referring to FIG. 2A, a first photo-resist layer 201 is formed over the substrate 200 by coating. Next, a photolithography process is performed to expose the region 203 for forming a blue filter as shown in FIG. 2B. Then, a blue color dielectric layer 202 is formed in the substrate 200 and the first photo-resist layer 201 is removed as shown in FIG. 2C.

When fabricating the green color filter, referring to FIG. 3A, a second photo-resist layer 301 is first formed over the substrate 200 and the blue color dielectric layer 202 by coating. Next, a photolithography process is performed to expose the region 303 for forming a green filter as shown in FIG. 3B. Then, a green color dielectric layer 302 is formed in the substrate 200 and the second photo-resist layer 301 is removed as shown in FIG. 3C.

When fabricating the red color filter, referring to FIG. 4A, a third photo-resist layer 401 is first formed over the substrate 200, the blue color dielectric layer 202 and the green color dielectric layer 302 by coating. Next, a photolithography process is performed to expose the region 403 for forming a red filter as shown in FIG. 4B. Then, a red color dielectric layer 402 is formed in the substrate 200 and the third photo-resist layer 401 is removed as shown in FIG. 4C. Finally, the color filter with a blue color, a red color and a green color as shown in FIG. 1 is finished.

The photolithography method for forming the color filter has the following disadvantages. First, the substrate has to be removed from the reaction room of the vacuum evaporator to strip the photo-resist layer after forming the color dielectric layer. Then, the substrate has to be put into the reaction room again to perform the next step of forming another color dielectric layer. However, particles can contaminate the substrate when the substrate is removed from the reaction room. Moreover, the reaction room may also be contaminated if the contaminated substrate is put into the reaction room again for performing the next process step. Additionally, the pumping step, the heating step and the temperature-dropping step have to be performed repeatedly in the photolithography method, which wastes time. Finally, misalignment can affect the final product when using the photolithography method.

### SUMMARY OF THE INVENTION

According to the above descriptions, the conventional color filter fabrication method has these disadvantages. For example, the substrate has to be removed from the reaction room to strip the photo-resist. Particles may contaminate the substrate in this step. Moreover, the pumping step, the heating step and the dropping temperature step must be performed repeatedly in the conventional method, which wastes time. Additionally, misalignment can affect the final product when using the photolithography method.

Therefore, it is a main object of the present invention to provide a color filter manufacturing method that does not require use of the photo-resist during the fabrication process. In the provided method, the substrate need not be removed from the reaction room to strip the photo-resist. Therefore, particle contamination can be avoided.

It is another object of the present invention to provide a color filter fabrication method that replaces the photo-resist used in the conventional method with a removable mask. Therefore, the misalignment problem can be solved.

It is yet another object of the present invention to provide a color filter fabrication method that does not require repetition of the pumping, heating and temperature-dropping steps. Therefore, this present invention can save processing time.

The present invention provides a color filter fabrication method. According to the present invention, the removable mask and a substrate are posited in a vacuum evaporator, in which the removable mask is used to cover partially the substrate and expose the region where the first color dielectric layer is to be formed. When this evaporating process is finished, the removable mask is rotated and moved to the next position. There the removable mask exposes another region where the second color dielectric layer is to be formed, and the next evaporating process is performed. In accordance with the present invention, it is not necessary to remove the substrate out the reaction room to strip the photo-resist. Therefore, the present invention can avoid particle contamination. Moreover, the method does not require repeated performance of the pumping, heating and temperature-dropping steps, which saves processing time. Photolithography is not used in the present invention. Therefore, misalignment does not occur.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a schematic top view of a color filter with a blue color (B), a red color (R) and a green color (G);

FIGS. 2A to 2C illustrate a schematic top view of forming a blue color filter by the conventional photolithography method;

FIGS. 3A to 3C illustrate a schematic top view of forming a green color filter by the conventional photolithography method;

FIGS. 4A to 4C illustrate a schematic top view of forming a red color filter by the conventional photolithography method;

FIG. 5A illustrates a schematic diagram of an evaporator used in the present invention;

FIG. 5B illustrates a schematic enlarged diagram of a removable mask and a substrate in accordance with the present invention, wherein W is the width of the shadow generated by the removable mask;

FIGS. 6A to 6C illustrate a schematic top view of a removable mask in accordance with the first preferred embodiment of the present invention;

FIG. 6D illustrates a schematic top view of a color filter with a blue color (B), a red color (R) and a green color (G) that is formed in accordance with the first preferred embodiment;

FIGS. 7A to 7C illustrate a schematic top view of a removable mask in accordance with the second preferred embodiment of the present invention; and

FIG. 7D illustrates a schematic top view of a color filter with a blue color (B), a red color (R) and a green color (G) that is formed in accordance with the second preferred embodiment.

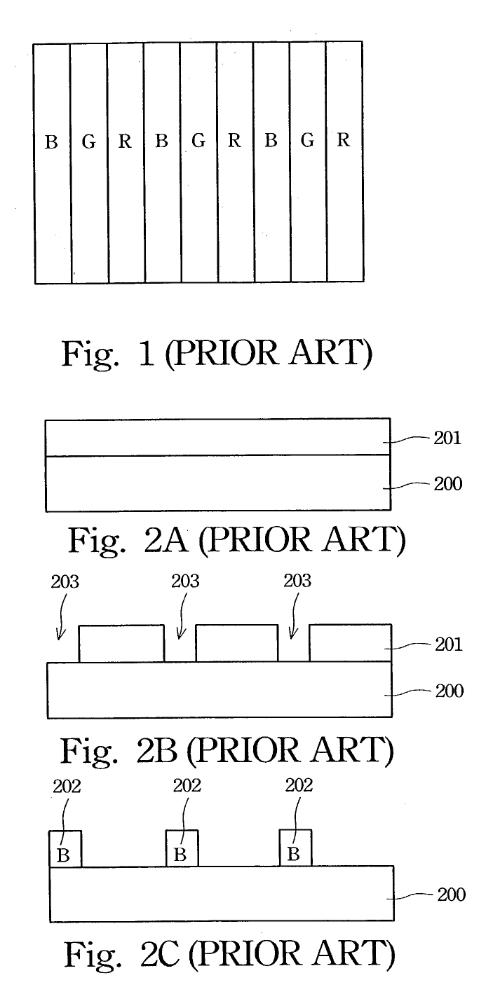

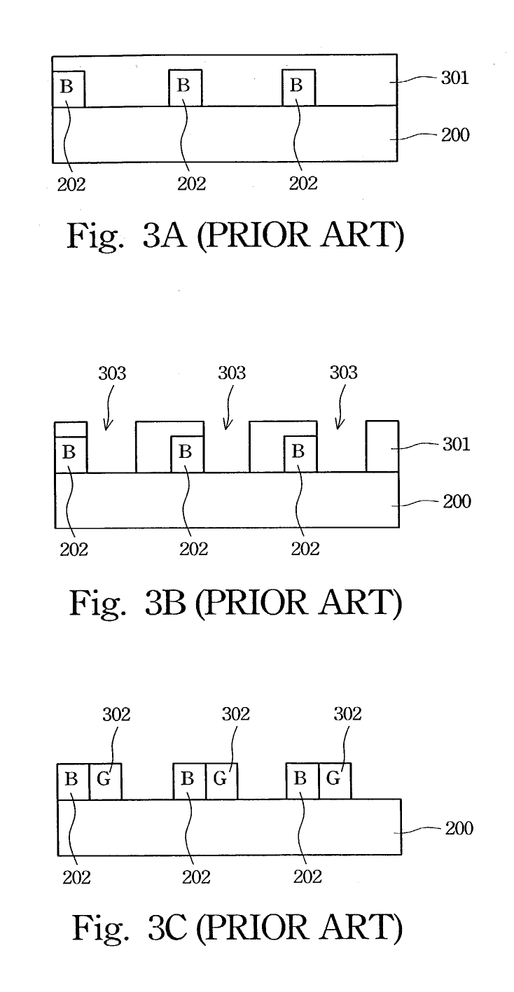

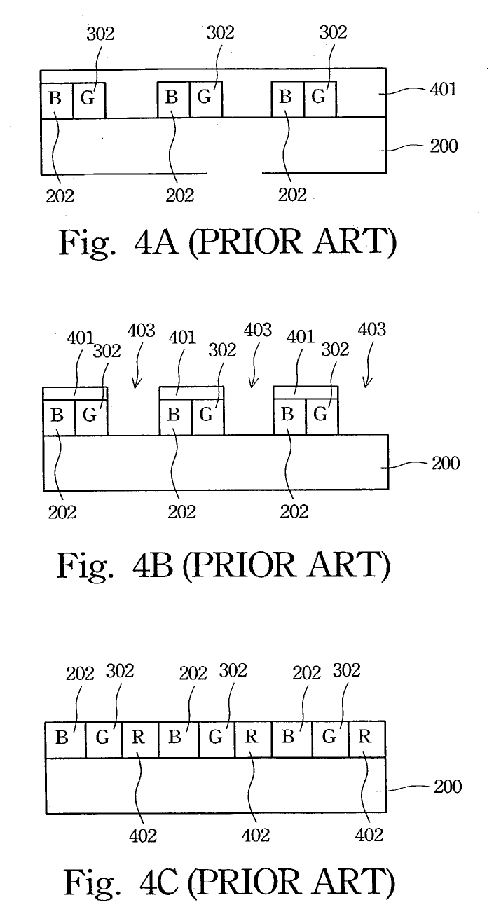

### DETAILED DESCRIPTION OF THE PREFERRED EMBODIMENT

Without limiting the spirit and scope of the present invention, the color filter manufacturing method proposed in the present invention is illustrated with one preferred embodiment. One with ordinary skill in the art, upon acknowledging the embodiment, can apply the manufacturing method of the present invention to fabricate various color filters. In accordance with the present invention, it is not necessary to remove the substrate from the reaction room to strip the photo-resist. Therefore, the present invention can avoid particle contamination. Moreover, the method does not require repeated performance of the pumping, heating and temperature-dropping steps, and thus also can save process time. Photolithography is not used in the present invention. Therefore, misalignment does not occur. The application of the present invention is not limited by the preferred embodiments described in the following.

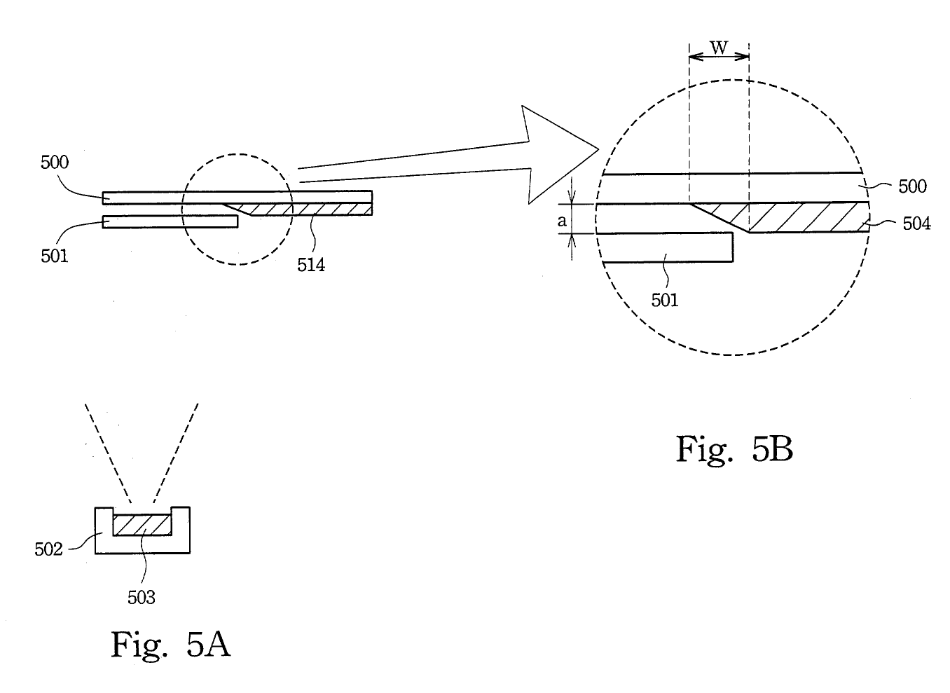

Referring to FIG. 5A, a schematic diagram of an evaporator used in the present invention is illustrated. The present invention uses a removable mask 501 to replace the photo-resist to form a color filter. During processing, the removable mask 501 and the substrate 500 are placed in the vacuum evaporator, and the removable mask 501 is located between the substrate 500 and the evaporated material 503. A crucible 502 is used to carry the evaporated material 503. The thin film 504 is a dielectric thin film that is formed by evaporation or sputtering.

Referring to FIG. 5B, a schematic enlarged diagram of a removable mask 501 and a substrate 500 is illustrated in accordance with the present invention. The removable mask 501 and the substrate 500 are separated by a distance “a”. This distance “a” causes the thickness of the thin film 504 near the edge of the removable mask 501 to decrease progressively in a specific region W. This situation is called a mask shadow effect. The thickness of the thin film 504 is thinner in the specific region W, which shifts the original optical efficiency. Therefore, the mask shadow effect has to be controlled within a specific range. The specific region W generated by the mask shadow effect is generally less than 0.3 mm.

According to the present invention, the removable mask 501 is used to partially cover the substrate 500 and expose the region where the first color dielectric layer 504 is formed. The removable mask 501 is rotated to the next position where another region is exposed for forming the second color dielectric layer after the first dielectric layer 504 is formed on the substrate 500. The described fabrication process can be repeatedly performed until the color filter is finished. A silicon wafer can be used to form the removable mask 501.

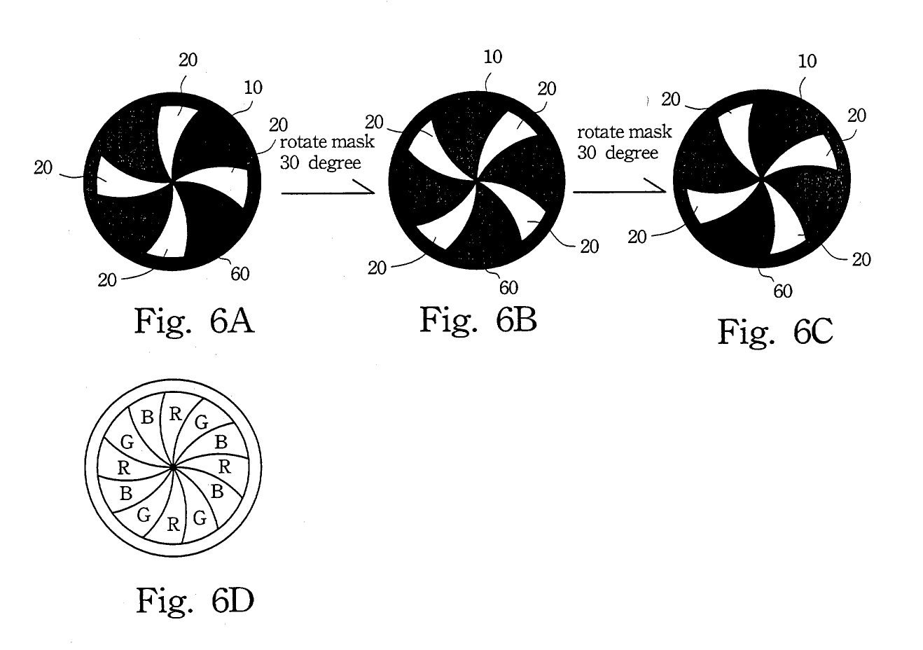

FIGS. 6A to 6C illustrate a schematic top view of a removable mask in accordance with the first preferred embodiment of the present invention. Referring to FIG. 6A, the removable mask 60 includes a hollow region 20 and a cover region 10. The hollow region 20 is used to expose the region for forming the color dielectric layer. In other words, the color dielectric layer is formed on the substrate through the hollow region 20. The cover region 10 is used to cover the region not necessary for the color dielectric layer. In accordance with the preferred embodiment of the present invention, the removable mask 60 is used to form a color filter with a blue color (B), a red color (R) and a green color (G). Therefore, each color occupies a region with an angle of 30 degrees. In other words, an angle of 90 degrees exists between any two adjacent hollow regions 20.

FIG. 6D illustrates a schematic top view of a color filter with a blue color (B), a red color (R) and a green color (G) formed by using the removable mask 60 depicted in FIG. 6A in the evaporator depicted in FIG. 5A. When fabricating the red color filter, the hollow region 20 of the removable mask 60 can expose a specific region of a substrate for forming the red color dielectric layer. The cover region 10 of the removable mask 60 covers other regions not designated for the red color dielectric layer. Then, an evaporating or sputtering process is performed to form the red color filter (R) on the substrate. Because an angle of 90 degrees exists between any two adjacent hollow regions 20, an angle of 90 degrees also exists between any two adjacent red color filters (R) as shown in FIG. 6D, indicated by the letter “R”.

When fabricating the green color filter, referring to FIG. 6B, a rotating machine (not shown in the figure) is used to rotate clockwise the removable mask 60 to shift the same by an angle of 30 degrees. It is noted that the removable mask 60 also can be rotated counterclockwise. Because every dielectric layer occupies an angle of 30 degrees, the hollow region 20 of the removable mask 60 can expose a specific region of a substrate for forming the green color dielectric layer. The cover region 10 of the removable mask 60 covers other regions not designated for green color dielectric layer formation. Then, an evaporating or sputtering process is performed to form the green color filter (G) on the substrate. Because an angle of 90 degrees exists between any two adjacent hollow regions 20, an angle of 90 degrees also exists between any two adjacent green color filters (G) as shown in FIG. 6D indicated by the letter “G”.

When fabricating the blue color filter, referring to FIG. 6C, the rotating machine is used again to rotate clockwise the removable mask 60 to shift the same an angle of 30 degrees. Because every dielectric layer occupies an angle of 30 degrees, the hollow region 20 of the removable mask 60 can expose a specific region of a substrate for forming the blue color dielectric layer. The cover region 10 of the removable mask 60 covers regions not designated for blue color dielectric layer formation. Then, an evaporating or sputtering process is performed to form the blue color filter (B) on the substrate. Because an angle of 90 degrees exists between any two adjacent hollow regions 20, an angle of 90 degrees also exists between any two adjacent blue color filters (B) as shown in FIG. 6D indicated by the letter “B”. It is noted that the removable mask can be designed in accordance with the required color filter.

On the other hand, the color filter of the present invention also can be fabricated by overlapping different films in a specific region. These films can be band-pass optical films, band-off optical films, high-pass optical films, low-pass optical film or anti-reflection optical films. For example, the blue color dielectric layer can be fabricated by overlapping film 1 and film 2. The blue color dielectric layer has a pass wavelength from 420 nm to 490 nm and a cut-off wavelength from 500 nm to 700 nm. Film 1 has a pass wavelength from 420 nm to 590 nm and a cut-off wavelength from 600 nm to 700 nm. Film 2 has a pass wavelength from 420 nm to 490 nm, 608 nm to 700 nm and a cut-off wavelength from 500 nm to 600. Moreover, the red color dielectric layer can be fabricated by overlapping film 2 and film 3. The red color dielectric layer has a pass wavelength from 610 nm to 700 nm and a cut-off wavelength from 420 nm to 600 nm. Film 3 has a pass wavelength from 500 nm to 700 nm and a cut-off wavelength from 420 nm to 490 nm. The green color dielectric layer can be fabricated by overlapping film 1 and film 3. The green color dielectric layer has a pass wavelength from 520 nm to 590 nm and a cut-off wavelength from 420 nm to 600 nm.

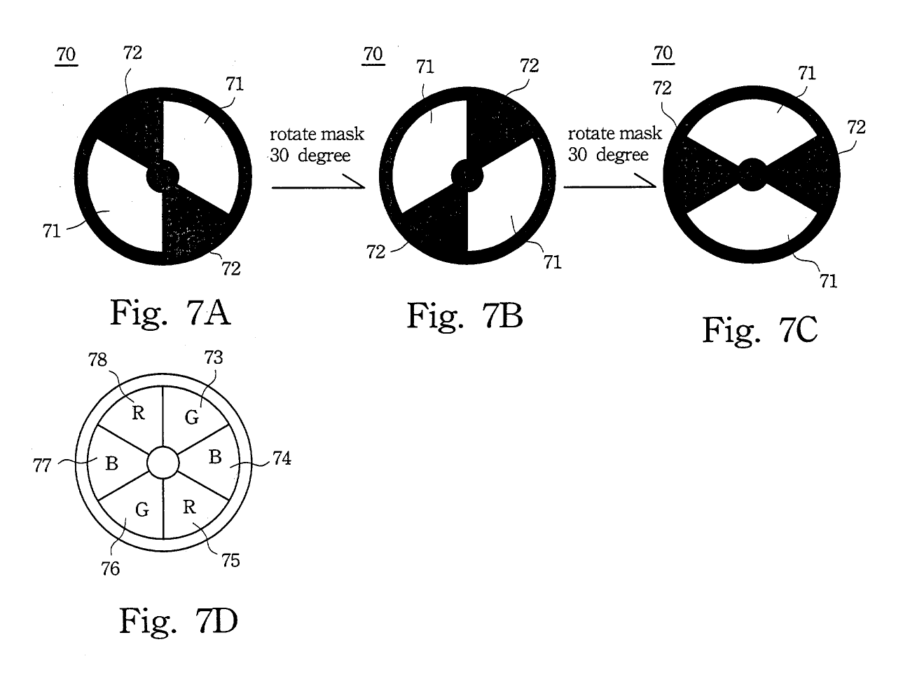

Therefore, in accordance with the above method, the removable mask depicted in FIG. 7A can be used to form the color filter with a blue color (B), a red color (R) and a green color (G) depicted in FIG. 7D. Referring to FIG. 7A, the removable mask 70 includes a hollow region 71 and a cover region 72. The hollow region 71 is used to expose the region for forming the color dielectric layer. In other words, the color dielectric layer is formed on the substrate through the hollow region 71. The cover region 72 is used to cover regions not necessary for forming this dielectric layer. In accordance with the preferred embodiment of the present invention, each color dielectric layer is fabricated by overlapping different color films. Therefore, the hollow region 71 occupies a region with an angle of 60 degrees. A silicon wafer can be used to form the removable mask 70.

FIG. 7D illustrates a schematic top view of a color filter with a blue color (B), a red color (R) and a green color (G) that is formed by using the removable mask 70 depicted in FIG. 7A in the evaporator depicted in FIG. 5A. First, referring to FIG. 7A, film 1 is formed in the substrate through the hollow region 71. Next, referring to FIG. 7B, the rotating machine is used to rotate clockwise the removable mask 70 to shift the same by an angle of 30 degrees. It is noted that the removable mask 70 also can be shifted counterclockwise. Then, film 2 is formed in the substrate through the hollow region 71. Finally, referring to FIG. 7C, the rotating machine (not shown in the figure) is used again to rotate clockwise the removable mask 70 to shift the same by an angle of 30 degrees. Then, the film 3 is formed in the substrate through the hollow region 71.

At this time, referring to FIG. 7D, film 1 and film 2 are jointly formed in the region 74 and region 77 to form the blue color dielectric layer. Film 2 and film 3 are jointly formed in region 75 and region 78 to form the red color dielectric layer. Film 1 and film 3 are jointly formed in region 73 and region 76 to form the green color dielectric layer.

According to above descriptions, it is not necessary to remove the substrate from the reaction room to strip the photo-resist in the present invention. Therefore, the present invention can avoid particle contamination. Moreover, it is not necessary to perform repeatedly the pumping, heating and temperature-dropping steps in the present invention. Therefore, the present invention also saves process time. Moreover, the present invention does not use photolithography. Therefore, misalignment does not occur.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A color filter fabrication method, wherein said color filter is formed over a substrate, said method comprising these steps:
(a) placing said substrate and a removable mask in a reaction room, wherein said removable mask partially exposes said substrate;
(b) forming a thin film over said substrate using said removable mask as a mask;
(c) removing said removable mask to expose partially said substrate; and
(d) repeating said step (b) to said step (c) to finish said color filter.

2. The color filter fabrication method according to claim 1, wherein a silicon wafer is used to form said removable mask.

3. The color filter fabrication method according to claim 1, wherein removing said removable mask is a clockwise or counterclockwise rotation of said removable mask.

4. The color filter fabrication method according to claim 1, wherein said thin film is formed over said substrate by evaporation or sputtering.

5. The color filter fabrication method according to claim 1, wherein said thin film is a band-pass or band-off optical thin film.

6. The color filter fabrication method according to claim 1, wherein said thin film is a high-pass or low-pass optical thin film.

7. The color filter fabrication method according to claim 1, wherein said thin film is an anti-reflection optical thin film.

8. The color filter fabrication method according to claim 1, wherein said removable mask forms a shadow region less than 0.3 mm in said substrate.

9. A color filter fabrication method, said method comprising these steps:
(e) placing a substrate and a removable mask in a reaction room, wherein said removable mask is located over said substrate surface and said removable mask has a hollow region for partially exposing said substrate surface;
(f) forming a thin film over said substrate using said removable mask as a mask;
(g) removing said removable mask to expose partially said substrate; and
(h) repeating said step (f) to said step (g) to finish said color filter.

10. The color filter fabrication method according to claim 9, wherein said hollow region sharp is related to said thin film.

11. The color filter fabrication method according to claim 9, wherein a silicon wafer is used to form said removable mask.

12. The color filter fabrication method according to claim 9, wherein removing said removable mask is a clockwise or counterclockwise rotation of said removable mask.

13. The color filter fabrication method according to claim 9, wherein said thin film is formed over said substrate by evaporation or sputtering.

14. The color filter fabrication method according to claim 11, wherein said thin film is a band-pass or band-off optical thin film.

15. The color filter fabrication method according to claim 9, wherein said thin film is a high-pass or low-pass optical thin film.

16. The color filter fabrication method according to claim 9, wherein said thin film is an anti-reflection optical thin film.

17. The color filter fabrication method according to claim 9, wherein said removable mask forms a shadow region less than 0.3 mm in said substrate.
